(19) United States
(12) Patent Application Publication
(10) Pub. No.: US 2020/0351772 A1
(43) Pub. Date: Nov. 5, 2020

(54) BRACKETED SCANS

(71) Applicant: QUALCOMM Incorporated, San Diego, CA (US)

(72) Inventors: Sandip Homchaudhuri, San Jose, CA (US); Dinesh Davuluru, San Jose, CA (US); Vincent Knowles Jones, IV, Redwood City, CA (US); Ravi Konda, San Jose, CA (US)

(21) Appl. No.: 16/399,696

(22) Filed: Apr. 30, 2019

(51) Int. Cl. H04W 52/02; H04W 48/08; H04W 64/00

(52) U.S. Cl. CPC H04W 52/0216; H04W 64/006; H04W 48/08

(57) ABSTRACT

Methods, systems, and devices for wireless communications are described. The method may include determining a parameter from a physical layer convergence protocol preamble of a management frame associated with one or more information elements, determining that the parameter associated with the one or more information elements is outside a range, and performing a low-power operation for at least a remaining portion of the management frame based on determining that the parameter associated with the one or more information elements is outside the range.

### BACKGROUND

The following relates generally to wireless communications, and more specifically to bracketed scans.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that communicates with one or more stations (STAs) or mobile devices.

The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink and uplink. The downlink (or forward link) may refer to the communication link from the AP to the STA, and the uplink (or reverse link) may refer to the communication link from the STA to the AP.

In some examples, one or more wireless devices (e.g., AP, STA) may repeatedly perform various scans in or of a wireless network. In some examples, an accumulation of these scans may consume a substantial amount of power, which may result in a reduced battery life, among other disadvantages, for given wireless devices. Accordingly, such wireless devices may benefit from improved scanning techniques.

### SUMMARY

The described techniques relate to improved methods, systems, devices, and apparatuses that support bracketed scans. Generally, the described techniques provide for analyzing parameters associated with scans to determine whether to continue processing the scan or to terminate processing the scan based at least in part on the analyzed parameters. In some examples, the present techniques may include terminating a scan process based on thresholds associated with a specified range (e.g., bracket). In some examples, the present techniques may include scanning for devices that meet one or more criteria. In some examples, the present techniques include terminating a scan process, entering a low-power mode for a specified or determined time period, and then exiting the low-power mode to perform one or more other operations, such as performing or processing another scan.

A method of bracketed scanning at a device in a wireless network is described. The method may include determining a parameter from a physical layer convergence protocol preamble of a management frame associated with one or more information elements, determining that the parameter associated with the one or more information elements is outside a range, and performing a low-power operation for at least a remaining portion of the management frame based on determining that the parameter associated with the one or more information elements is outside the range.

An apparatus for bracketed scanning at a device in a wireless network is described. The apparatus may include a processor, memory in electronic communication with the processor, and instructions stored in the memory. The instructions may be executable by the processor to cause the apparatus to determine a parameter from a physical layer convergence protocol preamble of a management frame associated with one or more information elements, determine that the parameter associated with the one or more information elements is outside a range, and perform a low-power operation for at least a remaining portion of the management frame based on determining that the parameter associated with the one or more information elements is outside the range.

Another apparatus for bracketed scanning at a device in a wireless network is described. The apparatus may include means for determining a parameter from a physical layer convergence protocol preamble of a management frame associated with one or more information elements, determining that the parameter associated with the one or more information elements is outside a range, and performing a low-power operation for at least a remaining portion of the management frame based on determining that the parameter associated with the one or more information elements is outside the range.

A non-transitory computer-readable medium storing code for bracketed scanning at a device in a wireless network is described. The code may include instructions executable by a processor to determine a parameter from a physical layer convergence protocol preamble of a management frame associated with one or more information elements, determine that the parameter associated with the one or more information elements is outside a range, and perform a low-power operation for at least a remaining portion of the management frame based on determining that the parameter associated with the one or more information elements is outside the range.

Some examples of the method, apparatuses, and non-transitory computer-readable medium described herein may further include operations, features, means, or instructions for determining a second parameter from a second physical layer convergence protocol preamble of a second management frame that may be associated with one or more information elements, determining that the second parameter associated with the one or more information elements may be within the range, and identifying an access point associated with the second management frame based on determining that the second parameter associated with the one or more information elements may be within the range.

Some examples of the method, apparatuses, and non-transitory computer-readable medium described herein may further include operations, features, means, or instructions for determining that an information element from the one of the one or more information elements may be within an information element range, and confirming the identifying of the access point based on the information element may be within the information element range.

In some examples of the method, apparatuses, and non-transitory computer-readable medium described herein, the remaining portion of the management frame includes a portion of the management frame from a legacy signal field of the management frame to a frame check sequence field of the management frame.

Some examples of the method, apparatuses, and non-transitory computer-readable medium described herein may further include operations, features, means, or instructions for determining that an information element from the one of the one or more information elements may be outside an information element range, where performing the low-power operation includes performing the low-power operation for at least the remaining portion of the management frame based at least in part on determining that the information element from the one of the one or more information elements is outside the information element range.

In some examples of the method, apparatuses, and non-transitory computer-readable medium described herein, performing the low-power operation for at least the remaining portion of the management frame may include operations, features, means, or instructions for performing the low-power operation to the end of the management frame plus a short interframe space time period.

In some examples of the method, apparatuses, and non-transitory computer-readable medium described herein, performing the low-power operation for at least the remaining portion of the management frame may include operations, features, means, or instructions for performing the low-power operation to the end of the management frame plus an acknowledgement time period.

In some examples of the method, apparatuses, and non-transitory computer-readable medium described herein, determining the parameter may include operations, features, means, or instructions for determining a parameter from a legacy short training field of the physical layer convergence protocol, where sending an acknowledgment may be bypassed when determining the parameter indicates a probe response associated with the parameter may be a directed probe response.

In some examples of the method, apparatuses, and non-transitory computer-readable medium described herein, determining the parameter may include operations, features, means, or instructions for determining a parameter from a media access control header of the management frame.

Some examples of the method, apparatuses, and non-transitory computer-readable medium described herein may further include operations, features, means, or instructions for estimating one or more parameters from information contained in the physical layer convergence protocol.

In some examples of the method, apparatuses, and non-transitory computer-readable medium described herein, the parameters may include any one of a received signal strength indicator, signal to noise ratio, low correlation PHY error, or legacy signal decoding error, or any combination thereof.

### BRIEF DESCRIPTION OF THE DRAWINGS

FIG. 1 illustrates an example of a system for wireless communications that supports bracketed scans in accordance with aspects of the present disclosure.

FIG. 2 illustrates an example of a system for wireless communications that supports bracketed scans in accordance with aspects of the present disclosure.

FIG. 3 illustrates an example of a management frame that supports bracketed scans in accordance with aspects of the present disclosure.

FIG. 4 illustrates an example of a management frame that supports bracketed scans in accordance with aspects of the present disclosure.

FIGS. 5 and 6 show block diagrams of devices that support bracketed scans in accordance with aspects of the present disclosure.

FIG. 7 shows a block diagram of a communications manager that supports bracketed scans in accordance with aspects of the present disclosure.

FIG. 8 shows a diagram of a system including a device that supports bracketed scans in accordance with aspects of the present disclosure.

FIGS. 9 and 10 show flowcharts illustrating methods that support bracketed scans in accordance with aspects of the present disclosure.

### DETAILED DESCRIPTION

Scan power continues to be a drag on innovations, for example, at the upper layer of wireless networks. Search or scan is performed for a variety of reasons, but often many scan results are discarded based on signal strength, signal to noise ratio (SNR), and other information elements (IEs) of interest (e.g., IEs associated with scans that may be used as described herein to determine whether to continue processing a scan or to enter a low power mode). Other techniques needlessly use power to scan these access point aspects (e.g., Probe Responses, Beacons, Probe Requests), and these may ultimately be rejected by the high-level operating system (HLOS).

The present techniques reduce power consumption in scanning operations. In some examples, this is based on early termination of given scan processes and may relate to analysis of parameters associated with a scan. The present techniques may include analyzing the parameters associated with one or more scans in relation to one or more criteria to determine whether to continue processing the scan or to terminate the scan process early (e.g., drop given scan results by a station or user device associated with the scan). In some examples, the present techniques may be based on terminating the scan process for devices, such as access points (APs), based on thresholds associated with range (e.g., received signal strength indicator (RSSI), signal-to-noise ratio (SNR)). In some examples, the present techniques may include scanning for devices that meet one or more criteria. For example, the present techniques may include scanning for APs with RSSI in a given range, for APs that have given capabilities, etc. If such a device, such as an AP, is not ascertained from a first part (e.g., a relatively early part) of the scan process, the other device (e.g., a station) may be configured to enter a low-power mode to save energy for the remainder of a time associated with the scan. As one example, the station may terminate the scan process, enter a low-power mode for a given time period, and then exit low-power mode to scan for another AP.

Aspects of the disclosure are initially described in the context of a wireless communications system. Aspects of the disclosure are also described in the context of a management frame. Aspects of the disclosure are further illustrated by and described with reference to apparatus diagrams, system diagrams, and flowcharts that relate to bracketed scans.

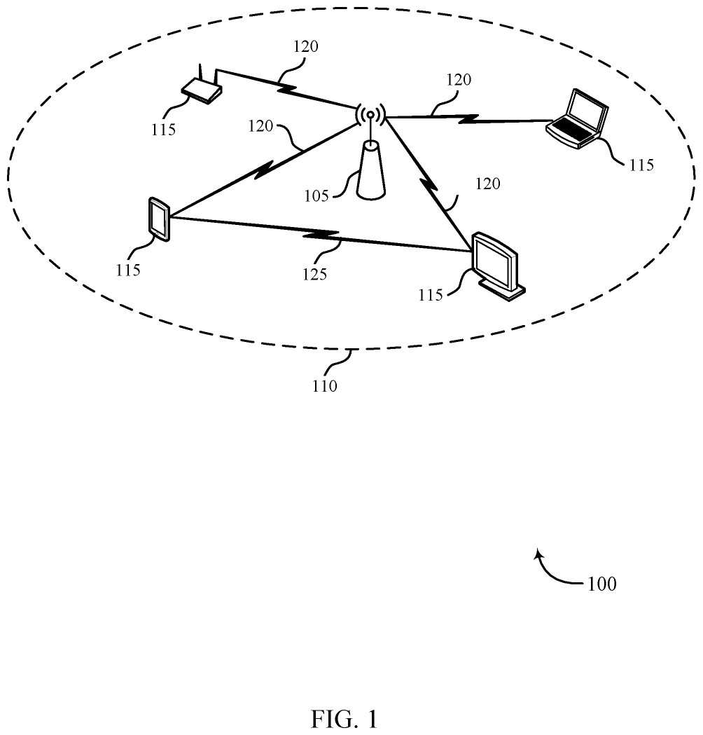

FIG. 1 illustrates an example of a wireless communication system 100, which may be a wireless local area network (WLAN) 100, (also known as a Wi-Fi network) that supports scanning enhancements (e.g., bracketed scans) in accordance with aspects of the present disclosure. The WLAN 100 may include an AP 105 and multiple associated STAs 115, which may represent devices such as mobile stations, smartphones, other handheld devices, netbooks, notebook computers, tablet computers, laptops, display devices (e.g., TVs, computer monitors), printers, appliances, etc. The AP 105 and the associated STAs 115 may represent a basic service set (BSS) or an extended service set (ESS). The various STAs 115 in the network may be configured to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS. These APs 105 and STAs 115 may communicate based on bracketed scans in accordance with aspects of the present disclosure.

A STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some examples, the coverage area 110 of an AP 105 may be divided into sectors. The WLAN 100 may include APs 105 of different types (e.g., metropolitan area, home network), with varying and overlapping coverage areas 110. Two STAs 115 may also communicate directly via a direct wireless link 125 regardless of whether both STAs 115 are in the same coverage area 110.

Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc. In other implementations, peer-to-peer connections or ad hoc networks may be implemented within WLAN 100. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

In some examples, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention-based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of a request to send (RTS) packet transmitted by a sending STA 115 (or AP 105) and a clear to send (CTS) packet transmitted by the receiving STA 115 (or AP 105). This may alert other devices within range of the sender and receiver not to transmit for the duration of the primary transmission. Thus, RTS/CTS may help mitigate a hidden node problem.

In some examples, an AP 105 may operate its BSS as per a baseline. For instance, enhanced distributed channel access (EDCA)-based contention may occur on the primary channel, while passive and active scanning may be performed in discovery channels. If the primary channel and the discovery channel are independent channels, then the AP 105 may utilize additional EDCA backoff counter for the discovery channel. In some examples, the AP 105 may count down in the primary channel, but may send transmissions of the discovery channel. In some examples, the AP 105 may duplicate a transmission, puncture a preamble, transmit given data units, etc. The transmitted data units may include a downlink single user (SU) or multi user (MU) physical layer convergence procedure (PLCP) protocol data unit (PPDU), a MAC packet data unit (MPDU), an aggregated MAC service data unit (AMSDU), etc.

In some examples, a FILS discovery frame (which may be referred to as an FD frame), or any management frame already scheduled for delivery (e.g., a beacon frame) may be transmitted with or included in a probe response, and may be sent in the discovery channel in a downlink SU PPDU, or a downlink MU PPDU (e.g., in broadcast RUs). For example, in a multi-user system, an RU in a downlink MU PPDU may carry a management frame. A DL MU PPDU may have several RUs, and each RU may carry an MPDU. The MPDU may be broadcast or individually addressed (e.g., determined based on the identifier associated with the RU). The RU carrying the discovery frame (e.g., an FD frame, or a broadcast probe response) may lie on the sub-channel corresponding to the discovery channel.

The rest of the RUs may carry individually addressed frames for other STAs 115 already associated with the AP 105. The downlink MU PPDU may be transmitted over an RU that falls on the discovery channel. The AP 105 may transmit PPDUs for STAs associated with the AP 105 over other RUs. In some examples, preamble punctured PPDUs may be sent if any other sub-channel is busy at a transmission time. In some examples, an AP 105 may determine whether to transmit a FILS discovery frame, a probe response, or a beacon frame, prior to the transmission time for sending such signals. That is, prior to a periodic beacon transmission, or prior to a probe response triggered by a probe request, an AP 105 may determine which type of frame or signal to transmit.

In some examples, an AP 105 or a STA 115 may identify, from a set of channels in a radio frequency spectrum band, a subset of discovery channels. The discovery channels may be designated for discovery signaling for device association. An AP 105 may transmit discovery information to a STA for determining one or more channel access rules or whether to associate with the access point over a discovery channel from the subset of discovery channels. In some examples, the AP 105 may receive a probe request from a STA 115 operating in an active scanning mode, and may transmit the discovery information in a probe response. In some examples, the AP 105 may transmit the discovery information in a periodic signal, such as a beacon, to a STA 115 operating in a passive scanning mode. The AP 105 may receive an association request from the STA 115, and may associate with the STA based on the association request and the discovery channel.

In some examples, a wireless device (e.g., AP 105 or STA 115) may implement bracketed scans in a wireless network (e.g., WLAN 100) to reduce power consumption associated with wireless devices scanning and dwelling on channels listening for responses, among other benefits. The present techniques of bracketed scans may be performed in wireless networks such as WLAN 100, as well as with any wireless technology, including but not limited to those based on the industrial, scientific, and medical (ISM) radio band or federal communication commission (FCC) band with a frame structure that includes at least a preamble field (e.g. PHY preamble), a payload field (e.g., media access control (MAC) payload), and an error detection field (e.g., cyclic redundancy check (CRC) field).

In some examples, the wireless device may be configured to scan for one or more (e.g., particular) requests, responses, and beacons such as APs with parameters in a given range, APs with one or more capabilities, etc. If such an AP does not exist, the wireless device may reduce power consumption (e.g., preserve battery power) by entering a low-power mode for a set time, then exit the low-power mode and perform another scan in search for an AP that exhibits the parameters in the given range and/or an AP with the particular capabilities. In some examples, a low-power mode may include at least one of powering down one or more components for a set duration. In some examples, low-power mode may include powering down one or more PHY components such as chips, powering down one or more components coupled with or associated with a PHY component, powering down one or more MAC components such as chips, powering down one or more components coupled with or associated with a MAC components such as chip, or powering down at least one RF component, or any combination thereof.

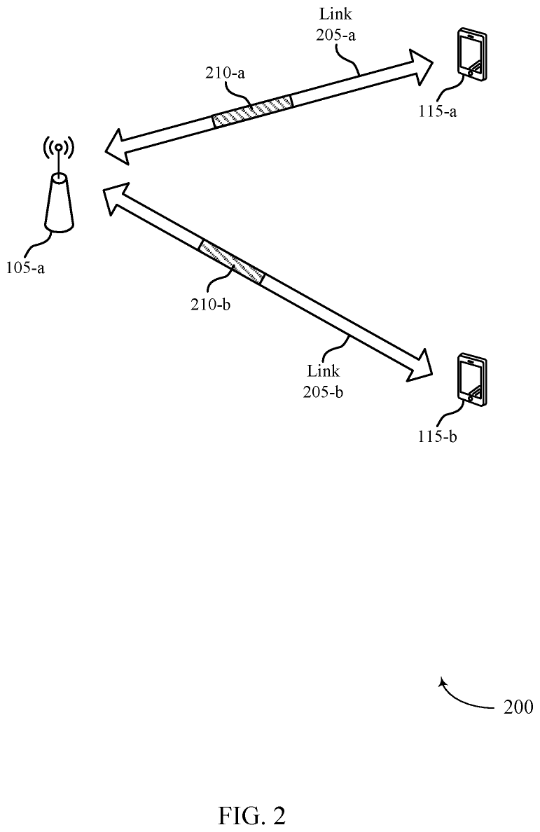

FIG. 2 illustrates an example of a wireless communication system 200, which may be a wireless local area network (WLAN) 200 that supports scanning enhancements (e.g., bracketed scans) in accordance with various aspects of the present disclosure. In some examples, WLAN 200 may implement aspects of WLAN 100. As illustrated, WLAN 200 may include AP 105-a and one or more stations (e.g., STA 115-a, STA 115-b). A wireless connection between AP 105-a and a STA 115 (e.g., STA 115-a, STA 115-b, etc.) may be referred to as a link 205 (a communication link), and each link may include one or more channels. In some examples, WLAN 200 may include multiple links such that AP 105-a may communicate with STA 115-a and STA 115-b. For example, STA 115-a may receive packets (e.g., MPDUs, PPDUs, AMSDUs, etc.) over link 205-a and STA 115-b may receive packets over both link 205-b. Communication over links 205-a and 205-b may include synchronized (e.g., simultaneous) or unsynchronized (e.g., asynchronous) communications, and may be uplink or downlink, or a combination of uplink and downlink during a particular duration of time.

In some examples, a wireless device (e.g., AP 105-a, STA 115-a, STA 115-b) may perform active scans (e.g., 2 Ghz, 5 Ghz non-dynamic frequency selection (DFS) channels). In some examples, the wireless device may be configured to reduce scan power in less-congested environments based on an adaptive dwell time. However, in relatively moderate to busy environments, the power reduction of the wireless device may progressively degenerate to using full receive Rx power while receiving probe responses of varying strength and probe requests from non-AP STA devices on channel.

For example, in relatively moderate to busy environments the power reduction techniques of STA 115-a may progressively degenerate to using full Rx power while receiving probe responses of varying strength and probe requests from STA 115-b. In some examples, in relatively moderate to busy environments STA 115-a may receive all probe responses and all probe requests from STA 115-b, resulting in STA 115-a consuming a relatively substantial amount of Rx power until all of the probe responses, probe requests, and/or beacons are received.

In some examples, a wireless device (e.g., AP 105-a, STA 115-a, STA 115-b) may perform passive scans (e.g., 5 Ghz non-DFS channels, 6 Ghz, extreme high throughput (EHT) channels). For passive 5 Ghz channels, the wireless device may dwell on channel for a set time period (e.g., at least 110 ms) while listening to packets of varying strength (e.g., listening to all packets such as probes responses, probe requests, beacons). In such cases, the wireless device may consume a relatively substantial amount of Rx power until all the packets are received (e.g., all probes responses, probe requests, beacons). For passive 6 Ghz/EHT channels, the wireless device may wait up to 20 ms for a management frame (e.g., fast initial link setup (FILS) discovery frame, beacon frame, probe response frame). After waiting for the 20 ms, the wireless device may send a probe request and remain on channel for a given dwell time. In passive and active scans, the wireless device may consume a relatively substantial amount of Rx power receiving all packets of all signal strengths (e.g., probes, requests, beacons), many of which may end up discarded due to the probes, requests, or beacons failing given criteria of a high level operating systems (HLOS) of the wireless device.

In accordance with aspects of the present disclosure, techniques that address power consumption from multiple scans are considered. Techniques, which are discussed in detail herein, generally include using bracketed scans to reduce power consumption of wireless devices associated with passive and active scans, among other advantages. In some examples, a wireless device (e.g., AP 105-a, STA 115-a, STA 115-b) may perform bracketed scans in a wireless network (e.g., WLAN 200) to reduce power consumption associated with passive and active scans.

In some examples, the wireless device may receive data from a packet or frame associated with a scan and analyze the data. For example, the wireless device may receive data associated with a probe request, a probe response, a beacon, etc., and analyze the received data. In some examples, the wireless device may determine whether to continue processing the data based on the analysis of the data. In one example, the wireless device may determine a parameter from a physical layer convergence protocol preamble of a management frame. In some examples, the management frame may be associated with one or more information elements.

In some examples, the wireless device may determine that the one or more parameters associated with the one or more information elements is outside a given range. For example, the wireless device may make one or more measurements and/or estimates in relation to the parameter to determine at least one value associated with the parameter. In some examples, the wireless device may compare a determined value to one or more thresholds to determine whether the determined value falls within a given range (e.g., that it does or does not fall within a given range). As one example, the parameter determined by the wireless device may include a value of a signal strength associated with the management frame. Accordingly, the wireless device may determine whether the value of the signal strength falls within a given signal strength range.

In some examples, the wireless device may perform a low-power operation (e.g., enter a low-power mode) based at least in part on whether the parameter is outside the given range. In some examples, the wireless device may perform the low-power operation for at least a remaining portion of the management frame based at least in part on determining that the parameter associated with the one or more information elements is outside the range.

For example, the wireless device may discard the rest of the management frame and enter a low-power state until at least the end of the management frame. In some examples, a wireless device (e.g., AP 105-a, STA 115-a, STA 115-b) may determine that a parameter associated with the one or more information elements is within a given range. In some examples, the wireless device may identify an access point associated with the management frame based at least in part on determining that the parameter associated with the one or more information elements is within the given range. Accordingly, the wireless device may be configured to conserve power by remaining in an active state for given frames, while entering a low-power state for other frames.

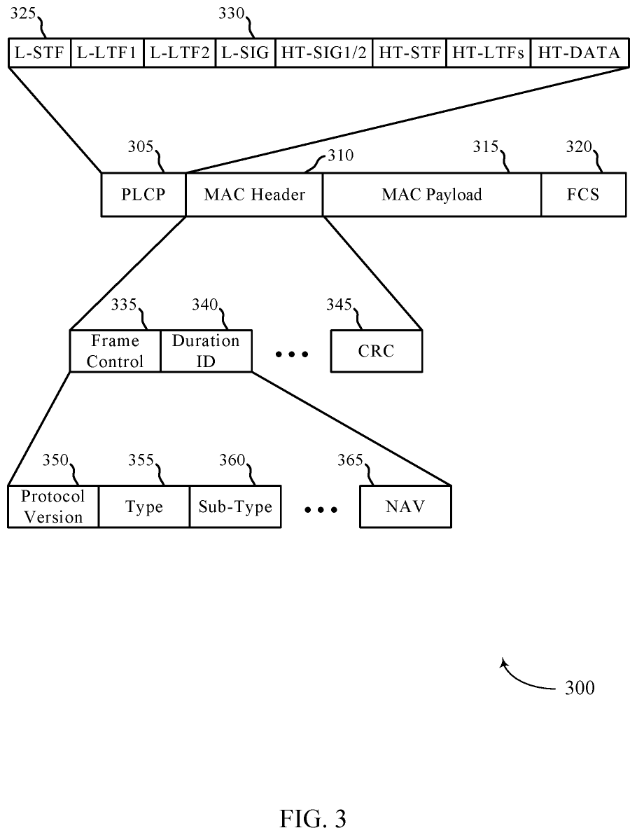

FIG. 3 illustrates an example of a management frame 300 that supports bracketed scans in accordance with aspects of the present disclosure. In some examples, management frame 300 may be implemented by or relate to aspects of wireless communication system 100.

In the illustrated example, management frame 300 may include physical layer convergence procedure (PLCP) field 305, media access control (MAC) header 310, MAC payload 315, and frame check sequence (FCS) field 320. As depicted, PLCP field 305 may include in legacy short training field (L-STF) 325 and legacy signal (L-SIG) field 330, among other possible fields such as legacy long training fields (L-LTF1, L-LTF2), high throughput signal fields (HT-SIG1, HT-SIG2), high throughput training fields (HT-STF, HT-LTF), and one or more high throughput data fields (HT-DATA). In some examples, the training fields (STF, LTF, etc.) may include information that allows a user device to detect a signal, perform frequency offset estimation, timing synchronization, etc. As shown, MAC header 310 may include a frame control field 335, a duration or association identifier (duration/ID) field 340, and a cyclic redundancy check (CRC) field 345. As depicted, frame control field 335 and duration/ID field 340 may include protocol version field 350, type field 355, sub-type field 360, and network allocation vector (NAV) field 365 among other fields

In some examples, scans may include associated scans and unassociated scans. In some examples, associated scans may include scans between a user device (e.g., STA 115 of FIG. 1 or FIG. 2) and an access point (e.g., AP 105 of FIG. 1 or FIG. 2) where the user device is linked to or has established a connection with the access point. In some examples, unassociated scans may include scans between the user device and any other device with which the user device is not currently connected or to which the user device is not currently linked.

In some examples, unassociated scans may include at least one of preferred network offload (PNO) scans, enhanced preferred network offload (ePNO) scans, connectivity scans, discovery scans (e.g., for location), bread-crumbing scans (e.g., for tracking), location scans, or auto join scans, or any combination thereof. In some examples, a user device may disregard any packet format associated with an unassociated scan other than Probe Response (e.g., type: 00, subtype: 0101) or Beacon (e.g., type: 00, subtype: 1000). In some examples, for unassociated scans a user device may bypass transmitting any class 2 or class 3 frames, or even class 1 frames other than Probe Request (type: 00, subtype: 0100) and, therefore, the user device may bypass adopting a NAV from a transmit Opportunity (TXOP) of an unassociated scan (e.g., from NAV field 365).

In some examples, the user device may operate based on thresholds associated with a range of values associated with a scan (e.g., received signal strength indicator (RSSI) and signal-to-noise ratio (SNR)). In some examples, the user device may operate out of a specified bracket (e.g., {rssi1, rssi2}). In some examples, the user device may estimate RSSI based at least in part on information from L-STF 325. In some examples, information from L-STF 325 may be referred to as a decision point (e.g., a first decision point). A decision point may include a field of management frame 300 that includes data the user device uses to determine whether to continue processing a scan or to enter a low power mode. In some examples, the user device may determine whether the estimated RSSI, as one example, is within the specified bracket. Other examples (e.g., different than RSSI) are also specifically contemplated and fall within the scope of the present disclosure. When the user device determines the estimated RSSI is outside of the desired bracket, the user device may perform a low power mode (e.g., deep low power operation) for at least the rest of management frame 300 from L-SIG field 330 to FCS 320.

In some examples, decoding L-SIG field 330 may enable the user device to identify the length of the management frame 300. In some examples, when decoding of L-SIG field 330 fails, the user device may suspend the bracketing operations. For example, when decoding of L-SIG field 330 fails the user device may suspend operating based on thresholds associated with the range of values associated with a scan. In some examples, the user device may retry to decode L-SIG field 330 in the same frame (e.g., management frame 300) or a subsequent frame. In some examples, the user device may resume operating based on thresholds associated with the range of values associated with a scan once the user device is able to decode the legacy signal field (e.g., L-SIG field 330).

In some examples, the low power mode user device enters may include a PHY lower power mode (e.g., nap mode), which may include at least one of shutting of PHY clocks, shutting of MAC clocks, shutting of radio frequency (RF) circuits, or any combination thereof. In some examples, the low power mode may include a light sleep mode, which may include powering down at least a voltage controlled oscillator (VCO).

In some examples, the low power mode may include a full power collapse, which may include at least one of powering down a PHY chip and all components associated with the PHY chip, powering down a MAC chip and all components associated with the MAC chip, powering down all RF components, or any combination thereof. In some examples, the full power collapse may include automatic powering up (e.g., auto-restore) based on lapsing a time period, processing at least a portion of a frame (e.g., management frame 300), or any combination thereof. For example, in some examples low power mode may be entered for at least a duration of a frame (e.g., a unwanted frame such as a duration of management frame 300 where a parameter of the management frame falls outside of a specified range of values associated with a scan).

In some examples, the low power mode may be extended beyond the end the unwanted frame. For example, the low power mode may extend beyond the unwanted frame for at least a time period associated with short interframe space (SIFS). In some examples, the user device may wake up after the SIF period and send an acknowledgement (ACK) message (e.g., an ACK for a directed probe request).

In some examples, the low power mode may extend beyond the unwanted frame for at least the SIFS time period as well as a time period associated with sending the ACK message (e.g., bypassing sending the ACK message by continuing in low power mode during the time period the ACK message would be sent). In some examples, a AP may not retry a probe response. Accordingly, due to an absence of having to perform data transmit or data receive operations, the user device may ignore sending the ACK in case the probe response is a directed one. Thus, the user device may use a parameter from L-STF 325 to determine whether to continue processing management frame 300 or to enter a low power mode, and upon entering the low power mode, the user device may bypass sending the ACK to remain in the low power mode beyond the duration of management frame 300.

In some examples, the decision point may be moved from a first decision point (e.g., L-STF 325) to a second decision point. In some examples, a decision of whether to process a frame or enter a low power mode may be based on both a first decision point (e.g., based on analysis of a parameter from PLCP 305) and a second decision point (e.g., based on analysis of a parameter from MAC header 310). In one example, the decision point may be moved to one or more fields of MAC header 310.

In some examples, by the time user device is analyzing the contents of the fields of MAC header 310, the user device may already have determined one or more parameters from management frame 300. For example, user device may have already determined at least one of RSSI from L-STF 325, a length of management frame 300, a basic service set identifier (BSSID) of an AP or other user device (e.g., a MAC address of the AP or the other user device), or any combination thereof. In some examples, the user device may enter a low power mode for a remainder of the management frame 300 (e.g., until FCS 320 to a SIFS time period, waking up to send an ACK for a directed probe request). In some examples, the user device may analyze a type field 355 or sub-type field 360 from MAC header 310 to determine whether to enter low power mode for a probe request initiated by any non-AP user device.

In some examples, associated scans may include roaming scans, discovery scans (e.g., location scans), bread-crumbing scans (e.g., tracking scans), etc. Associated scans may be on a home channel (e.g., a channel of a connected or linked AP) or a foreign channel (e.g., a channel from a non-connected or non-linked AP). In some examples, scans on foreign channels may be treated like unassociated scans, as there may be no motivation for the user device to acquire NAV and update it for scans on foreign channels. However, for scans on home channels, the user device may perform one or more operations to avoid being blacklisted by an AP based on a NAV violation or clobbering outgoing transmissions over a NAV period.

In one example, for associated scans a user device may enter a low power mode based at least in part on a decision point associated with MAC header 310. For example, the user device may analyze at least one of a frame type field 355 and sub-type field 360 to determine a type of management frame 300 (e.g., determine management frame 300 is a probe response, a probe request, a beacon).

In one example, the user device may perform one or more operations in relation to an associated scan, which may include entering a low-power mode based on at least one of determining management frame 300 is a probe response, estimating RSSI from L-STF 325, determining L-SIG 330, updating a NAV value based on NAV field 365 from MAC header 310, and determining the estimated RSSI outside the specified bracket of {rssi1, rssi2}. In some examples, for associated scans the user device may enter the low power mode for at least the duration of management frame 300. In some examples, for associated scans the user device may remain in the low power mode beyond the duration of management frame 300.

For example, the user device may enter the low power mode for the duration of management frame 300 plus a SIFS time period, or for the duration of management frame 300 plus a SIFS time period and an ACK time period. In some examples, for associated scans the user device may enter the low power mode for the duration of management frame 300 and the SIFS time period, but wake up to send an ACK message.

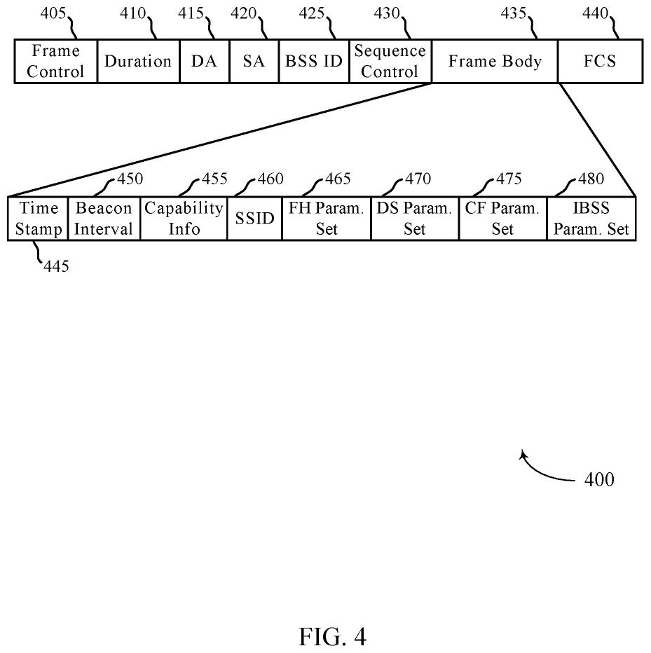

FIG. 4 illustrates an example of a management frame 400 that supports bracketed scans in accordance with aspects of the present disclosure. In some examples, management frame 400 may be implemented by or relate to aspects of wireless communication system 100.

In the illustrated example, management frame 400 may include frame control field 405, duration field 410, destination address (DA) field 415, source address (SA) field 420, basic service set identifier (BSS ID) field 425, sequence control field 430, frame body 435, and FCS 440. As shown, frame body 435 may include time stamp 445, beacon interval 450, capability information 455, service set identity (SSID) 460, frequency hopping (FH) parameter set 465, direct sequence (DS) parameter set 470, contention free (CF) parameter set 475, independent basic service set (IBSS) parameter set 480.

As indicated herein, a user device (e.g., STA 115 of FIG. 1 or FIG. 2) may be configured to perform bracketed scans. In some examples, the bracketing may be performed on estimations performed by the user device on one or more parameters from a physical layer convergence procedure (PLCP) preamble (e.g., PLCP field 305 from FIG. 3). In some examples, the bracketing parameters may include RSSI, SNR, specified PHY errors (e.g., low correlation, L-SIG decoding error). In some examples, the bracketing may be performed on given information elements (IEs) from a MAC payload (e.g., MAC payload 315 from FIG. 3), such as contents inside a beacon or probe response, etc. In some examples, management frame 400 may be an example of a probe frame or beacon frame. In one example, the bracketing may be performed on one or more IEs to determine whether a value of an IE is outside a specified bracket (e.g., {ie1, ie2, . . . ieN}).

In some examples, the IEs may include at least one of beacon interval 450, capability information 455, SSID 460, FH parameter set 465, DS parameter set 470, CF parameter set 475, IBSS parameter set 480, or any combination thereof. In some examples, capability information 455 may include at least one of high throughput (HT), very high throughput (VHT), or high efficiency (HE), or any combination thereof. When a value of an IE is outside a specified bracket, then the user device may discard the rest of the frame (e.g., management frame 400) and enter a low power mode until at least the end of the frame (e.g., until the end of the frame, until the end of the frame plus a SIFS time period, until the end of the frame plus a SIFS time period and an ACK time period).

In some examples, a frame check sequence (e.g., FCS 440) of the IEs may or may not be computed. Accordingly, in some examples, the user device may estimate the RSSI from the PLCP preamble, and may use the estimated RSSI to qualify at least one of the one or more IEs when performing bracketing based on the one or more IEs (e.g., qualify an integrity of at least one of the one or more IEs). In one example, the user device may determine that a probability of error in the MAC payload is less than a given threshold when the estimated RSSI is greater than a minimum RSSI threshold (e.g., when estimated RSSI>minimum_threshold_rssi_mcs_x, probability of error in payload is <Th2). In some examples, when the estimated RSSI is greater than the minimum RSSI threshold, the user device may compare a determined IE (e.g., estimated IE) to an IE bracket. When the determined IE is not within the IE bracket, then the user device may terminate the rest of management the frame and enter a low power mode.

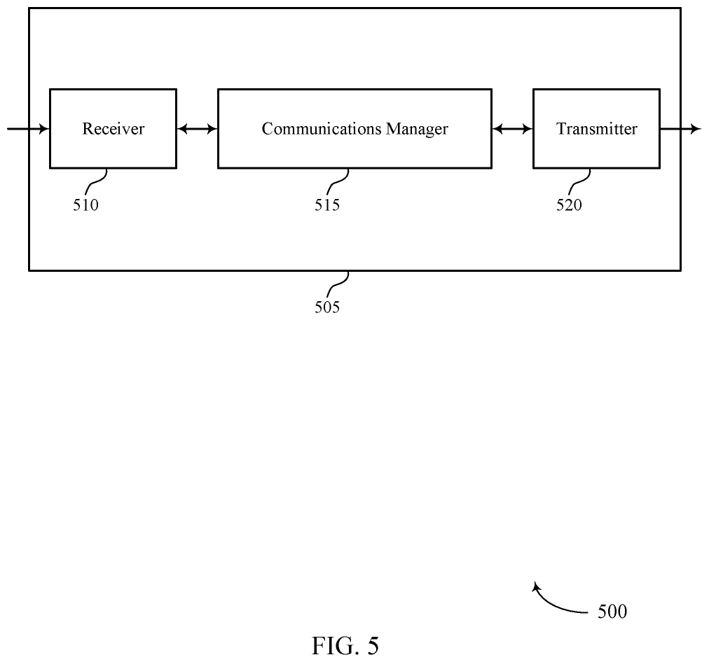

FIG. 5 shows a block diagram 500 of a device 505 that supports bracketed scans in accordance with aspects of the present disclosure. The device 505 may be an example of aspects of a device as described herein. The device 505 may include a receiver 510, a communications manager 515, and a transmitter 520. The device 505 may also include a processor. Each of these components may be in communication with one another (e.g., via one or more buses).

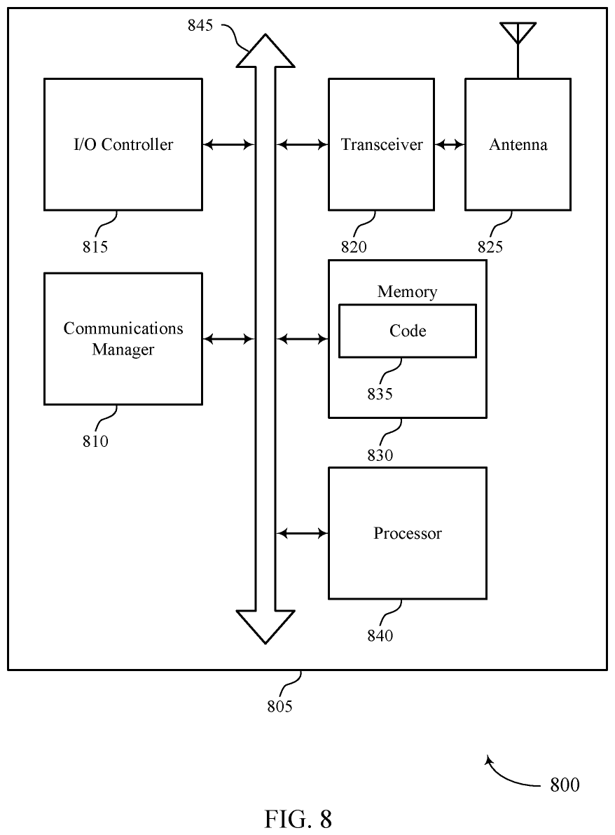

The receiver 510 may receive information such as packets, user data, or control information associated with various information channels (e.g., control channels, data channels, and information related to bracketed scans). Information may be passed on to other components of the device 505. The receiver 510 may be an example of aspects of the transceiver 820 described with reference to FIG. 8. The receiver 510 may utilize a single antenna or a set of antennas.

The communications manager 515 may determine a parameter from a physical layer convergence protocol preamble of a management frame associated with one or more information elements, determine that the parameter associated with the one or more information elements is outside a range, and perform a low-power operation for at least a remaining portion of the management frame based on determining that the parameter associated with the one or more information elements is outside the range. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

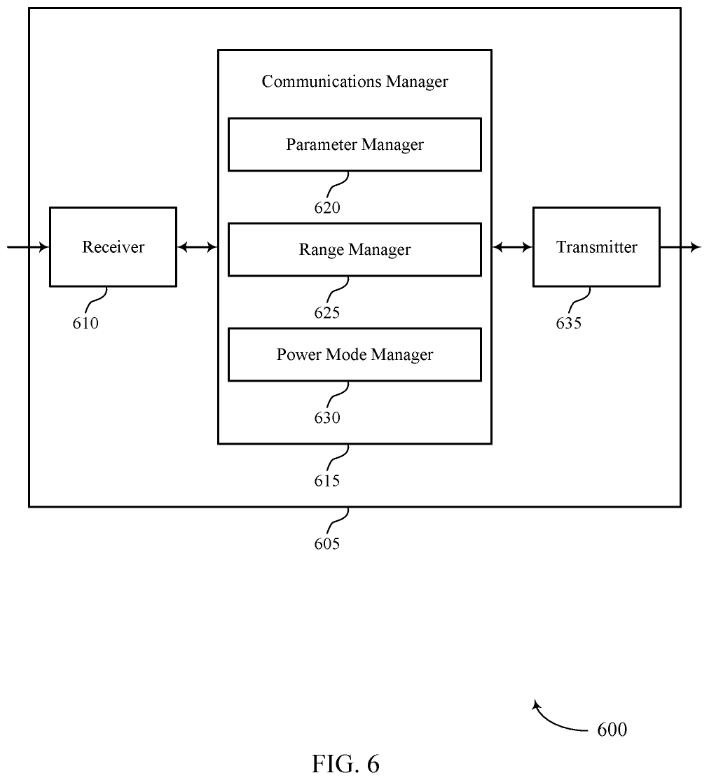

FIG. 6 shows a block diagram 600 of a device 605 that supports bracketed scans in accordance with aspects of the present disclosure. The device 605 may be an example of aspects of a device 505 or STA 115 or AP 105 as described herein. The device 605 may include a receiver 610, a communications manager 615, and a transmitter 635. The device 605 may also include a processor. Each of these components may be in communication with one another (e.g., via one or more buses).

The receiver 610 may receive information such as packets, user data, or control information associated with various information channels (e.g., control channels, data channels, and information related to bracketed scans). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a parameter manager 620, a range manager 625, and a power mode manager 630. The communications manager 615 may be an example of aspects of the communications manager 810 described herein.

The parameter manager 620 may determine a parameter from a physical layer convergence protocol preamble of a management frame associated with one or more information elements. The range manager 625 may determine that the parameter associated with the one or more information elements is outside a range. The power mode manager 630 may perform a low-power operation for at least a remaining portion of the management frame based on determining that the parameter associated with the one or more information elements is outside the range.

The transmitter 635 may transmit signals generated by other components of the device 605. In some examples, the transmitter 635 may be collocated with a receiver 610 in a transceiver module. For example, the transmitter 635 may be an example of aspects of the transceiver 820 described with reference to FIG. 8. The transmitter 635 may utilize a single antenna or a set of antennas.

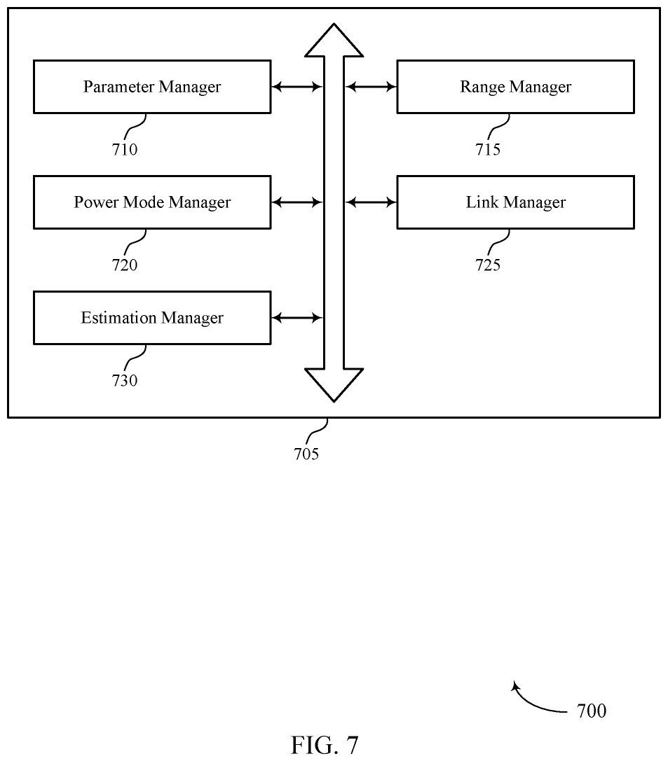

FIG. 7 shows a block diagram 700 of a communications manager 705 that supports bracketed scans in accordance with aspects of the present disclosure. The communications manager 705 may be an example of aspects of a communications manager 515, a communications manager 615, or a communications manager 810 described herein. The communications manager 705 may include a parameter manager 710, a range manager 715, a power mode manager 720, a link manager 725, and an estimation manager 730. Each of these modules may communicate, directly or indirectly, with one another (e.g., via one or more buses).

The parameter manager 710 may determine a parameter from a physical layer convergence protocol preamble of a management frame associated with one or more information elements.

In some examples, the parameter manager 710 may determine a parameter from a legacy short training field of the physical layer convergence protocol, where sending an acknowledgment is bypassed when determining the parameter indicates a probe response associated with the parameter is a directed probe response. In some examples, the parameter manager 710 may determine a parameter from a media access control header of the management frame. In some examples, the parameter manager 710 may determine a parameter from a media access control payload of the management frame. In some examples, the parameter manager 710 may determine one or more information elements from the media access control header, or from the media access control payload, or from both. In some examples, the parameters may include a received signal strength indicator, signal to noise ratio, low correlation PHY error, legacy signal decoding error, any parameter from the media access header, any parameter from the media access payload, or any combination thereof.

The range manager 715 may determine that the parameter associated with the one or more information elements is outside a range. In some examples, the range manager 715 may determine that an information element from the one of the one or more information elements is within an information element range.

In some examples, range manager 715 may determine that an information element from the one of the one or more information elements is outside an information element range. In some examples, performing the low-power operation includes power mode manager 720 performing the low-power operation for at least the remaining portion of the management frame based at least in part on range manager 715 determining that the information element from the one of the one or more information elements is outside the information element range (e.g. outside information element range {ie1, ie2} as one example).

The power mode manager 720 may perform a low-power operation for at least a remaining portion of the management frame based on determining that the parameter associated with the one or more information elements is outside the range. In some examples, the remaining portion of the management frame includes a portion of the management frame that spans from a legacy signal field of the management frame to a frame check sequence field of the management frame. Thus in some examples, power mode manager 720 may cause a user device to enter a low-power mode from a legacy signal field of the management frame to a frame check sequence field of the management frame.

In some examples, the power mode manager 720 may perform the low-power operation to at least the end of the management frame. In some examples, the power mode manager 720 may perform the low-power operation to the end of the management frame plus a certain period of time after the end of the management frame. In some examples, the power mode manager 720 may perform the low-power operation to the end of the management frame plus a short interframe space time period that occurs after the management frame. In some examples, the power mode manager 720 may perform the low-power operation to the end of the management frame plus an acknowledgement time period that occurs after the management frame. In some examples, the power mode manager 720 may perform the low-power operation to the end of the management frame plus a short interframe space time period and an acknowledgement time period that occur after the end of the management frame.

In some examples, the range manager 715 may determine that the parameter associated with the one or more information elements is within the range. In some examples, the parameter manager 710 may determine a second parameter from a second physical layer convergence protocol preamble of a second management frame that is associated with one or more information elements. In some examples, the range manager 715 may determine that the second parameter associated with the one or more information elements is within the range.

The link manager 725 may identify an access point associated with the second management frame based on determining that the parameter or the second parameter associated with the one or more information elements is within the range. In some examples, the link manager 725 may confirm the identifying of the access point based on the information element is within the information element range. The estimation manager 730 may estimate one or more parameters from information contained in the physical layer convergence protocol.

FIG. 8 shows a diagram of a system 800 including a device 805 that supports bracketed scans in accordance with aspects of the present disclosure. The device 805 may be an example of or include the components of device 505, device 605, or a device as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may determine a parameter from a physical layer convergence protocol preamble of a management frame associated with one or more information elements, determine that the parameter associated with the one or more information elements is outside a range, and perform a low-power operation for at least a remaining portion of the management frame based on determining that the parameter associated with the one or more information elements is outside the range.

The I/O controller 815 may manage input and output signals for the device 805. The I/O controller 815 may also manage peripherals not integrated into the device 805. In some examples, the I/O controller 815 may represent a physical connection or port to an external peripheral. In some examples, the I/O controller 815 may utilize an operating system such as iOS®, ANDROID®, MS-DOS®, MS-WINDOWS®, OS/2, UNIX®, LINUX®, or another known operating system. In other cases, the I/O controller 815 may represent or interact with a modem, a keyboard, a mouse, a touchscreen, or a similar device. In some examples, the I/O controller 815 may be implemented as part of a processor. In some examples, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some examples, the wireless device may include a single antenna 825. However, in some examples the device may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some examples, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some examples, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting bracketed scans).

The code 835 may include instructions to implement aspects of the present disclosure, including instructions to support wireless communications. The code 835 may be stored in a non-transitory computer-readable medium such as system memory or other type of memory. In some examples, the code 835 may not be directly executable by the processor 840 but may cause a computer (e.g., when compiled and executed) to perform functions described herein.

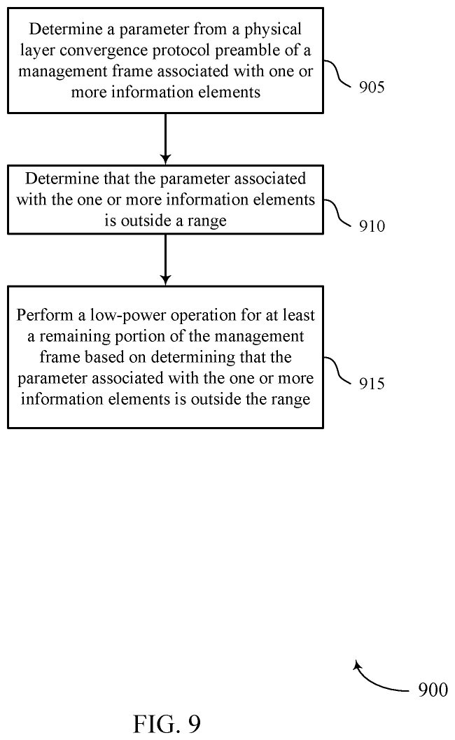

FIG. 9 shows a flowchart illustrating a method 900 that supports bracketed scans in accordance with aspects of the present disclosure. The operations of method 900 may be implemented by a device or its components as described herein. For example, the operations of method 900 may be performed by a communications manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 905, the device may determine a parameter from a physical layer convergence protocol preamble of a management frame associated with one or more information elements. The operations of 905 may be performed according to the methods described herein. In some examples, aspects of the operations of 905 may be performed by a parameter manager as described with reference to FIGS. 5 through 8.

At 910, the device may determine that the parameter associated with the one or more information elements is outside a range. The operations of 910 may be performed according to the methods described herein. In some examples, aspects of the operations of 910 may be performed by a range manager as described with reference to FIGS. 5 through 8.

At 915, the device may perform a low-power operation for at least a remaining portion of the management frame based on determining that the parameter associated with the one or more information elements is outside the range. The operations of 915 may be performed according to the methods described herein. In some examples, aspects of the operations of 915 may be performed by a power mode manager as described with reference to FIGS. 5 through 8.

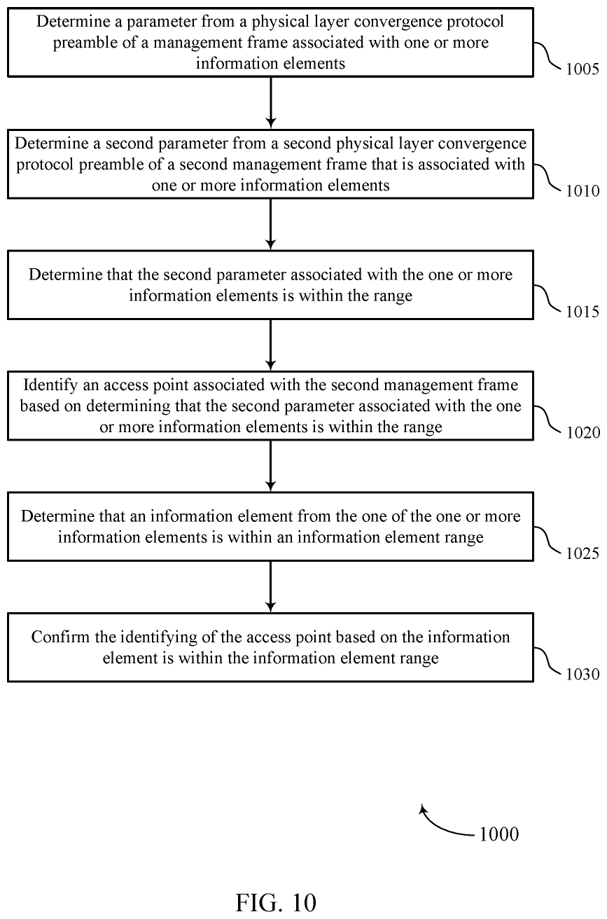

FIG. 10 shows a flowchart illustrating a method 1000 that supports bracketed scans in accordance with aspects of the present disclosure. The operations of method 1000 may be implemented by a device or its components as described herein. For example, the operations of method 1000 may be performed by a communications manager as described with reference to FIGS. 5 through 8. In some examples, a device may execute a set of instructions to control the functional elements of the device to perform the functions described herein. Additionally or alternatively, a device may perform aspects of the functions described herein using special-purpose hardware.

At 1005, the device may determine a parameter from a physical layer convergence protocol preamble of a management frame associated with one or more information elements. The operations of 1005 may be performed according to the methods described herein. In some examples, aspects of the operations of 1005 may be performed by a parameter manager as described with reference to FIGS. 5 through 8.

At 1010, the device may determine a second parameter from a second physical layer convergence protocol preamble of a second management frame that is associated with one or more information elements. The operations of 1010 may be performed according to the methods described herein. In some examples, aspects of the operations of 1010 may be performed by a parameter manager as described with reference to FIGS. 5 through 8.

At 1015, the device may determine that the second parameter associated with the one or more information elements is within the range. The operations of 1015 may be performed according to the methods described herein. In some examples, aspects of the operations of 1015 may be performed by a range manager as described with reference to FIGS. 5 through 8.

At 1020, the device may identify an access point associated with the second management frame based on determining that the second parameter associated with the one or more information elements is within the range. The operations of 1020 may be performed according to the methods described herein. In some examples, aspects of the operations of 1020 may be performed by a link manager as described with reference to FIGS. 5 through 8.

At 1025, the device may determine that an information element from the one of the one or more information elements is within an information element range. The operations of 1025 may be performed according to the methods described herein. In some examples, aspects of the operations of 1025 may be performed by a range manager as described with reference to FIGS. 5 through 8.

At 1030, the device may confirm the identifying of the access point based on the information element is within the information element range. The operations of 1030 may be performed according to the methods described herein. In some examples, aspects of the operations of 1030 may be performed by a link manager as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for bracketed scanning at a device in a wireless network, comprising:
determining a parameter from a physical layer convergence protocol preamble of a management frame associated with one or more information elements;
determining that the parameter associated with the one or more information elements is outside a range; and
performing a low-power operation for at least a remaining portion of the management frame based at least in part on determining that the parameter associated with the one or more information elements is outside the range.

2. The method of claim 1, further comprising:
determining a second parameter from a second physical layer convergence protocol preamble of a second management frame that is associated with one or more information elements;
determining that the second parameter associated with the one or more information elements is within the range; and
identifying an access point associated with the second management frame based at least in part on determining that the second parameter associated with the one or more information elements is within the range.

3. The method of claim 2, further comprising:
determining that an information element from the one of the one or more information elements is within an information element range; and
confirming the identifying of the access point based at least in part on the information element is within the information element range.

4. The method of claim 1, wherein the remaining portion of the management frame includes a portion of the management frame from a legacy signal field of the management frame to a frame check sequence field of the management frame.

5. The method of claim 1, further comprising:
determining that an information element from the one of the one or more information elements is outside an information element range, wherein performing the low-power operation comprises performing the low-power operation for at least the remaining portion of the management frame based at least in part on determining that the information element from the one of the one or more information elements is outside the information element range.

6. The method of claim 1, wherein performing the low-power operation for at least the remaining portion of the management frame comprises:
performing the low-power operation to an end of the management frame plus a short interframe space time period.

7. The method of claim 1, wherein performing the low-power operation for at least the remaining portion of the management frame comprises:
performing the low-power operation until an end of the management frame plus an acknowledgement time period.

8. The method of claim 1, wherein determining the parameter comprises:
determining a parameter from a legacy short training field of the physical layer convergence protocol, wherein sending an acknowledgment is bypassed when determining the parameter indicates a probe response associated with the parameter is a directed probe response.

9. The method of claim 1, wherein determining the parameter comprises:
determining a parameter from a media access control header of the management frame.

10. The method of claim 1, wherein determining the parameter includes:
estimating one or more parameters from information contained in the physical layer convergence protocol.

11. The method of claim 1, wherein the parameters comprising at least one of a received signal strength indicator, signal to noise ratio, low correlation PHY error, or legacy signal decoding error, or any combination thereof.

12. An apparatus for bracketed scanning in a wireless network, comprising:
a processor, memory in electronic communication with the processor; and
instructions stored in the memory and executable by the processor to cause the apparatus to:
determine a parameter from a physical layer convergence protocol preamble of a management frame associated with one or more information elements;
determine that the parameter associated with the one or more information elements is outside a range; and
perform a low-power operation for at least a remaining portion of the management frame based at least in part on determining that the parameter associated with the one or more information elements is outside the range.

13. The apparatus of claim 12, wherein the instructions are further executable by the processor to cause the apparatus to:
determine a second parameter from a second physical layer convergence protocol preamble of a second management frame that is associated with one or more information elements;
determine that the second parameter associated with the one or more information elements is within the range; and
identify an access point associated with the second management frame based at least in part on determining that the second parameter associated with the one or more information elements is within the range.

14. The apparatus of claim 13, wherein the instructions are further executable by the processor to cause the apparatus to:
determine that an information element from the one of the one or more information elements is within an information element range; and
confirm the identifying of the access point based at least in part on the information element is within the information element range.

15. The apparatus of claim 12, wherein the remaining portion of the management frame includes a portion of the management frame from a legacy signal field of the management frame to a frame check sequence field of the management frame.

16. The apparatus of claim 12, wherein the instructions are further executable by the processor to cause the apparatus to:
determine that an information element from the one of the one or more information elements is outside an information element range, wherein performing the low-power operation comprises performing the low-power operation for at least the remaining portion of the management frame based at least in part on determining that the information element from the one of the one or more information elements is outside the information element range.

17. The apparatus of claim 12, wherein the instructions to perform the low-power operation for at least the remaining portion of the management frame are executable by the processor to cause the apparatus to:
perform the low-power operation until at least an end of the management frame plus a short interframe space time period.

18. The apparatus of claim 12, wherein the instructions to perform the low-power operation for at least the remaining portion of the management frame are executable by the processor to cause the apparatus to:
perform the low-power operation until an end of the management frame plus an acknowledgement time period.

19. The apparatus of claim 12, wherein the instructions to determine the parameter are executable by the processor to cause the apparatus to:
determine a parameter from a legacy short training field of the physical layer convergence protocol, wherein sending an acknowledgment is bypassed when determining the parameter indicates a probe response associated with the parameter is a directed probe response.

20. A non-transitory computer-readable medium storing code for bracketed scanning at a device in a wireless network, the code comprising instructions executable by a processor to:
determine a parameter from a physical layer convergence protocol preamble of a management frame associated with one or more information elements;
determine that the parameter associated with the one or more information elements is outside a range; and
perform a low-power operation for at least a remaining portion of the management frame based at least in part on determining that the parameter associated with the one or more information elements is outside the range.
